(19) United States
(12) Patent Application Publication
(10) Pub. No.: US 2025/0016602 A1
(43) Pub. Date: Jan. 9, 2025

(54) SLICE TRAFFIC MANAGEMENT

(71) Applicant: Telefonaktiebolaget LM Ericsson (publ), Stockholm (SE)

(72) Inventors: George Foti, Dollard des Ormeaux (CA); Ralf Keller, Würselen (DE); Peter Hedman, Helsingborg (SE); Maria Belen Pancorbo Marcos, Madrid (ES)

(21) Appl. No.: 18/708,278

(22) PCT Filed: Nov. 10, 2022
(86) PCT No.: PCT/IB2022/060837

§ 371 Date: May 8, 2024

Related U.S. Application Data
(60) Provisional application No. 63/277,887, filed on Nov. 10, 2021.

(51) Int. Cl. H04W 28/02; H04L 45/302; H04L 47/20; H04W 40/04; H04W 48/06

(52) U.S. Cl. CPC H04W 28/0215; H04L 45/306; H04L 47/20; H04W 40/04; H04W 48/06

(57) ABSTRACT

Systems and methods are disclosed for supporting traffic management capabilities under network control. In one embodiment, a method performed by a wireless communication device comprises receiving one or more User Equipment (UE) Route Selection Policy (URSP) rules from a network node, receiving traffic control information associated to the one or more URSP rules, and performing one or more actions based on the one or more URSP rules and the traffic control information. In this manner, the network is given control of slice traffic management such that the network can force the UE to perform an action(s) when the network thinks that such action(s) is beneficial.

### RELATED APPLICATIONS

This application claims the benefit of provisional patent application Ser. No. 63/277,887, filed Nov. 10, 2021, the disclosure of which is hereby incorporated herein by reference in its entirety.

### TECHNICAL FIELD

The present disclosure relates to a cellular communications system and, more specifically, traffic management in a cellular communications system.

### BACKGROUND

In the Third Generation Partnership Project (3GPP) Fifth Generation System (5GS), the User Equipment (UE) may need to know the Single Network Slice Selection Assistance Information (S-NSSAI) and the Data Network Name (DNN) to be used for each Protocol Data Unit (PDU) Session establishment. Note that the term DNN is used instead of Access Point Name (APN) in 5GS specifications. This and other information applicable for PDU Sessions establishment can be provisioned or provided by the Home Public Mobile Network (HPMN) using the UE Route Selection Policy (URSP), but in 3GPP it is not mandatory for the UE to support URSP. The Global System for Mobile communications Association (GSMA) has profiled in Permanent Reference Document (PRD) NG.114 that both the support of URSP rules and the support of the UE Configuration Update procedure for transparent UE Policy delivery is mandatory for the UE.

URSP includes a prioritized list of URSP rules. Each URSP rule contains
Rule Precedence: Determines the order the URSP rule is enforced in the UE.
Traffic descriptor: Used to determine whether the rule matches. May contain
   Application descriptors: Operating System Identifier (OSId) and Operating System Application Identifier(s) (OSAppID(s))
   Destination Internet Protocol (IP) or non-IP descriptors
   DNN. Rel 16: If using DNN as traffic descriptor, then DNN must not be in the Route Selection Descriptor according to 3GPP TS 23.503 (see, e.g., V17.2.0). Rel 17: If using DNN as traffic descriptor, then if DNN is in the Route Selection Descriptor, then the DNN in the Route Selection Descriptor will be used for the PDU session.
   Domain descriptors: Fully Qualified Domain Name (FQDN) or Service Uniform Resource Indicator (URI)
   Connection Capabilities
   Note: Mainly OSAppID and DNN are in focus of the industry alignment discussion. Also, the connection capabilities that contain a traffic category are also in focus of the industry alignment discussion.
List of Route Selection Descriptors (RSD). May contain the following and potentially additional things (i.e., the following is not the full list). For further details, see 3GPP TS 23.503, Table 6.6.2.1-3.
   Session and Service continuity (SSC) Mode Selection: single value
   Network Slice Selection: one or more S-NSSAI(s).
   DNN Selection: one or more DNN(s).
   PDU Session Type Selection: single value, e.g., IPV4v6, IPV6
   Access Type preference: 3GPP or non-3GPP
Route Selection Validation (Rel 16). May contain:
   Time Window
   Location Criteria

### Simplified Example: Rules for APP1 (Precedence 1 is Highest Priority)

Precedence 1: Slice 1, DNN1
Precedence 2: Slice 2, DNN1
Precedence 3: Slice 3, DNN3
   Note that APP1 may be indicated by a combination of OSApp ID and OS ID.

If the UE receives new URSP rules, then according to 3GPP TS 23.503 the UE shall reevaluate the received URSP rules for APP1 and other applications in a timely manner. So, there are no requirements in 3GPP TS 23.503 to do this reevaluation of the received URSP rules immediately. If the UE decides to reevaluate the URSP rules for APP1, 3GPP 23,503 says that this is done “for a newly detected application traffic”, then the UE operates as follows:
The UE checks if there is a valid RSD; the condition to be valid is that the S-NSSAI is in the Allowed NSSAI (nothing is said about UE to register the slice not already registered),
   In the example, if Slice 1, 2, and 3 are in the Allowed NSSAI all of them are valid.
The UE determines if there is an existing PDU Session that matches all components in the selected (valid) RSD.
   In the example, there is a PDU Session to Slice 3+DNN.
If a PDU Session exists, the UE routes the traffic to this PDU Session.
   Then, if for any reason the re-evaluation leads to a change of the application to PDU Session association, e.g., the application is to be associated with another PDU Session or a new PDU Session needs to be established, the UE may enforce such changes in a timely manner based on implementation, e.g., immediately or when UE enters CM-IDLE state.

3GPP TS 24.526 (see, e.g., V17.4.0) includes the following language in section 4.2.2.2 (emphasis added):
The UE may re-evaluate the URSP rules, to check if the change of the association of an application to a PDU session is needed, when:
   NOTE 10: The time when the UE performs the re-evaluation is up to UE implementation. It is recommended that the UE performs the re-evaluation in a timely manner.
   a) the UE performs periodic URSP rules re-evaluation based on UE implementation;
   b) the UE NAS layer indicates that an existing PDU session used for routing traffic of an application based on a URSP rule is released;
   c) the URSP is updated by the PCF;
   d) the UE NAS layer indicates that the UE performs inter-system change from S1 mode to N1 mode;
   e) the UE NAS layer indicates that the UE is successfully registered in N1 mode over 3GPP access or non-3GPP access;
   f) the UE establishes or releases a connection to a WLAN access and transmission of a PDU of the application via non-3GPP access outside of a PDU session becomes available/unavailable;
   g) the allowed NSSAI or the configured NSSAI is changed; or
   h) the LADN information is changed.
If the re-evaluation leads to a change of the association of an application to a PDU session, the UE may enforce such change immediately or when UE returns to 5GMM-IDLE mode.
   NOTE 11: The time when the UE enforces the change of the association of an application to a PDU Session is up to UE implementation. It is recommended that the UE performs the enforcement in a timely manner.
The URSP handling layer may request the UE NAS layer to release an existing PDU session after the re-evaluation.
   Thus, according to 3GPP TS 25.526, once URSP rules (e.g., newly received URSP rule) are reevaluated at the UE and the reevaluation leads to a change of the association of an application to a PDU session, the UE may enforce such change immediately or when the UE returns to 5GMM-IDLE mode.

### SUMMARY

Systems and methods are disclosed for supporting traffic management capabilities under network control. In one embodiment, a method performed by a wireless communication device comprises receiving one or more User Equipment (UE) Route Selection Policy (URSP) rules from a network node, receiving traffic control information associated to the one or more URSP rules, and performing one or more actions based on the one or more URSP rules and the traffic control information. In this manner, the network is given control of slice traffic management such that the network can force the UE to perform an action(s) when the network thinks that such action(s) is beneficial.

In one embodiment, the traffic control information comprises information that indicates when the wireless communication device is to evaluate or re-evaluate the one or more URSP rules.

In one embodiment, the traffic control information comprises information that indicates that the wireless communication device is to evaluate or re-evaluate the one or more URSP rules immediately.

In one embodiment, the traffic control information comprises information that indicates when the wireless communication device is to apply results of evaluation or re-evaluation the one or more URSP rules.

In one embodiment, the traffic control information comprises information that indicates that the wireless communication device is to apply results of evaluation or re-evaluation of the one or more URSP rules immediately following the evaluation or re-evaluation of the one or more URSP rules.

In one embodiment, the traffic control information comprises information that indicates when the wireless communication device is to both evaluate or re-evaluate the one or more URSP rules and apply results of the evaluation or re-evaluation of the one or more URSP rules.

In one embodiment, the traffic control information comprises information that indicates that the wireless communication device is to both evaluate or re-evaluate the one or more URSP rules and apply results of the evaluation or re-evaluation of the one or more URSP rules immediately.

In one embodiment, the traffic control information comprises information that indicates that the wireless communication device is to release an associated Protocol Data Unit (PDU) session and block traffic.

In one embodiment, the traffic control information comprises information that indicates: (a) that the wireless communication device is to release an associated PDU session and block traffic, (b) that the wireless communication device is to keep an associated PDU session if established, or (c) that the wireless communication device is to release an associated PDU session if there is a higher precedence URSP rule.

In one embodiment, the traffic control information comprises information that indicates: (a) that the wireless communication device is to release an associated PDU session and block traffic, (b) that the wireless communication device is to keep an associated PDU session if established, (c) that the wireless communication device is to release an associated PDU session if there is a higher precedence URSP rule, (d) that the wireless communication device is to re-register and first release an associated PDU session if there is a higher precedence URSP rule, or (e) that the wireless communication device is to re-register and release an associated PDU session after establishing a new PDU session due to a higher precedence URSP rule.

In one embodiment, the traffic control information comprises information that indicates that the wireless communication device is to stop using a particular network slice.

In one embodiment, the traffic control information comprises information that indicates that the wireless communication device is to block a particular application or traffic flow from accessing the network.

In one embodiment, the one or more URSP rules comprises a URSP rule, and receiving the traffic control information comprises receiving the traffic control information as part of the URSP rule.

In one embodiment, the one or more URSP rules comprises a set of URSP rules, and the traffic control information is applicable to the set of URSP rules. In one embodiment, the set of URSP rules comprises one or more URSP rules. In another embodiment, the set of URSP rules comprises two or more URSP rules. In one embodiment, the set of URSP rules belong to a same UE policy section.

In one embodiment, receiving the traffic control information comprises receiving the traffic control information comprised in a UE policy container.

In one embodiment, the traffic control information comprises one or more commands. In one embodiment, the one or more commands comprises a command to modify the one or more URSP rules by replacing a particular network slice in the one or more URSP rules with another network slice. In another embodiment, the one or more commands comprise a command that instructs the wireless communication device to stop using a particular network slice. In another embodiment, the one or more commands comprise a command that instructs the wireless communication device to block a particular application or Internet Protocol (IP) stream from accessing the network.

Corresponding embodiments of a wireless communication device are also disclosed. In one embodiment, a wireless communication device is adapted to receive one or more URSP rules from a network node, receive traffic control information associated to the one or more URSP rules, and perform one or more actions based on the one or more URSP rules and the traffic control information.

In another embodiment, a wireless communication device comprises one or more transmitters, one or more receivers, and processing circuitry associated with the one or more transmitters and the one or more receivers. The processing circuitry is configured to cause the wireless communication device to receive one or more URSP rules from a network node, receive traffic control information associated to the one or more URSP rules, and perform one or more actions based on the one or more URSP rules and the traffic control information.

Embodiments of a method performed by a network node are also disclosed.

In one embodiment, a method performed by a network node comprises sending one or more URSP rules to a wireless communication device and sending traffic control information associated to the one or more URSP rules to the wireless communication device.

In one embodiment, the traffic control information comprises information that indicates when the wireless communication device is to evaluate or re-evaluate the one or more URSP rules.

In one embodiment, the traffic control information comprises information that indicates that the wireless communication device is to evaluate or re-evaluate the one or more URSP rules immediately.

In one embodiment, the traffic control information comprises information that indicates when the wireless communication device is to apply results of evaluation or re-evaluation the one or more URSP rules.

In one embodiment, the traffic control information comprises information that indicates that the wireless communication device is to apply results of evaluation or re-evaluation of the one or more URSP rules immediately following the evaluation or re-evaluation of the one or more URSP rules.

In one embodiment, the traffic control information comprises information that indicates when the wireless communication device is to both evaluate or re-evaluate the one or more URSP rules and apply results of the evaluation or re-evaluation of the one or more URSP rules.

In one embodiment, the traffic control information comprises information that indicates that the wireless communication device is to both evaluate or re-evaluate the one or more URSP rules and apply results of the evaluation or re-evaluation of the one or more URSP rules immediately.

In one embodiment, the traffic control information comprises information that indicates that the wireless communication device is to release an associated PDU session and block traffic.

In one embodiment, the traffic control information comprises information that indicates: (a) that the wireless communication device is to release an associated PDU session and block traffic, (b) that the wireless communication device is to keep an associated PDU session if established, or (c) that the wireless communication device is to release an associated PDU session if there is a higher precedence URSP rule.

In one embodiment, the traffic control information comprises information that indicates: (a) that the wireless communication device is to release an associated PDU session and block traffic, (b) that the wireless communication device is to keep an associated PDU session if established, (c) that the wireless communication device is to release an associated PDU session if there is a higher precedence URSP rule, (d) that the wireless communication device is to re-register and first release an associated PDU session if there is a higher precedence URSP rule, or (e) that the wireless communication device is to re-register and release an associated PDU session after establishing a new PDU session due to a higher precedence URSP rule.

In one embodiment, the traffic control information comprises information that indicates that the wireless communication device is to stop using a particular network slice.

In one embodiment, the traffic control information comprises information that indicates that the wireless communication device is to block a particular application or traffic flow from accessing the network.

In one embodiment, the one or more URSP rules comprises a URSP rule, and sending the traffic control information comprises sending the traffic control information as part of the URSP rule.

In one embodiment, the one or more URSP rules comprises a set of URSP rules, and the traffic control information is applicable to the set of URSP rules. In one embodiment, the set of URSP rules comprises one or more URSP rules. In another embodiment, the set of URSP rules comprises two or more URSP rules. In one embodiment, the set of URSP rules belong to a same UE policy section.

In one embodiment, sending the traffic control information comprises sending the traffic control information comprised in a UE policy container.

In one embodiment, the traffic control information comprises one or more commands. In one embodiment, the one or more commands comprises a command to modify the one or more URSP rules by replacing a particular network slice in the one or more URSP rules with another network slice. In one embodiment, the one or more commands comprise a command that instructs the wireless communication device to stop using a particular network slice. In one embodiment, the one or more commands comprise a command that instructs the wireless communication device to block a particular application or IP stream from accessing the network.

Corresponding embodiments of a network node are also disclosed. In one embodiment, a network node is adapted to send one or more URSP rules to a wireless communication device and send traffic control information associated to the one or more URSP rules to the wireless communication device.

In another embodiment, a network node comprises processing circuitry configured to cause the network node to send one or more URSP rules to a wireless communication device and send traffic control information associated to the one or more URSP rules to the wireless communication device.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIGS. 2 and 3 illustrate example embodiments of the cellular communications system in which the cellular communications system is a Third Generation Partnership Project (3GPP) Fifth Generation System (5GS);

FIG. 4 illustrates the operation of a network node and a User Equipment (UE) in accordance with one example embodiment of the present disclosure;

FIGS. 5, 6, and 7 are schematic block diagrams of example embodiments of a network node; and

FIGS. 8 and 9 are schematic block diagrams of example embodiments of a wireless communication device such as a UE.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). UE behavior is not deterministic enough when using conventional solutions for re-evaluation and application of UE Route Selection Policy (URSP) rules, and there is a lack of network control of enabling a more deterministic behavior, e.g. when UE re-evaluates the rules and applies any new rules, and UE logic when not all Single Network Slice Selection Assistance Information's (S-NSSAIs) are registered, in Allowed NSSAI, and when there are some Protocol Data Unit (PDU) Sessions established. There is a need to support more traffic management capabilities under control of the network that are not supported in today's URSP. These traffic management capabilities include any one or more of the following:
Instructing an application or any identifiable traffic stream supported in today's URSP to immediately switch to another S-NSSAI;
Instructing an application or any identifiable traffic stream supported in today's URSP to immediately release all its PDU sessions;
Instructing the UE to deregister from a specific S-NSSAI, i.e., to exclude this S-NSSAI from Requested NSSAI in Registration request;
Instructing the UE to register a specific S-NSSAI, i.e., to include this S-NSSAI into Requested NSSAI in Registration request in general or for a specific traffic stream; and
Instructing the UE to stop using a slice completely for any traffic, and a different slice can be used by impacted applications.

Systems and methods are disclosed herein for fulfilling this need. In one embodiment, a URSP option is proposed. In another embodiment, network options are proposed. A hybrid may also be used.

A related problem is that there is currently no mechanisms available to steer traffic between different network slices or Data Network Names (DNNs) in a consistent and deterministic way and under control of the network.

Certain aspects of the present disclosure and their embodiments may provide solutions to the aforementioned or other challenges. Systems and methods are disclosed herein for supporting traffic management capabilities under control of the network that are not supported in today's URSP. In one embodiment, a URSP option is proposed. In another embodiment, network options are proposed. A hybrid may also be used.

Certain embodiments may provide one or more of the following technical advantage(s). Embodiments of the proposed solution(s) give the network more control of slice traffic management. The network can force the UE to perform an action(s) when the network thinks this is beneficial. This allows timelier change of usage of network slices for PDU sessions than if left to UE implementation and when the UE is turning into idle mode, which may in total be a long time span for a fleet of devices.

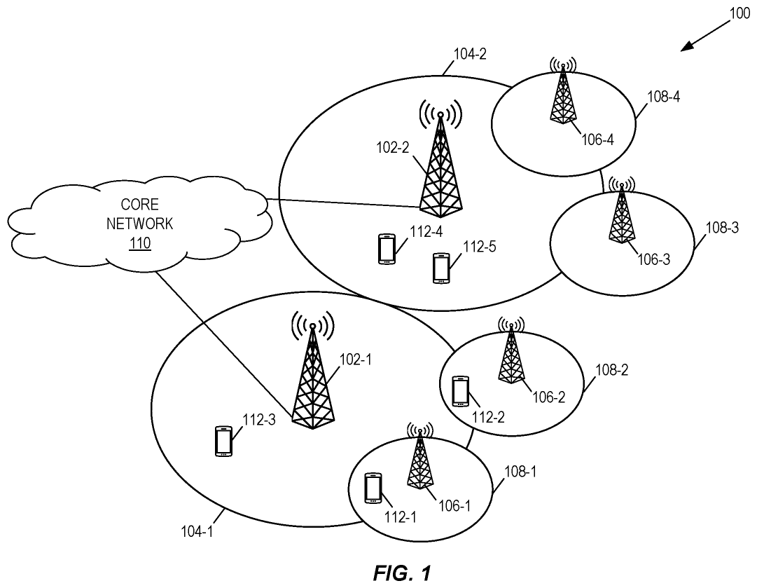

FIG. 1 illustrates one example of a cellular communications system 100 in which embodiments of the present disclosure may be implemented. In the embodiments described herein, the cellular communications system 100 is a 5G System (5GS) including a Next Generation RAN (NG-RAN) and a 5G Core (5GC); however, the present disclosure is not limited thereto. In this example, the RAN includes base stations 102-1 and 102-2, which in the NG-RAN include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such oftentimes referred to herein as UEs 112, but the present disclosure is not limited thereto.

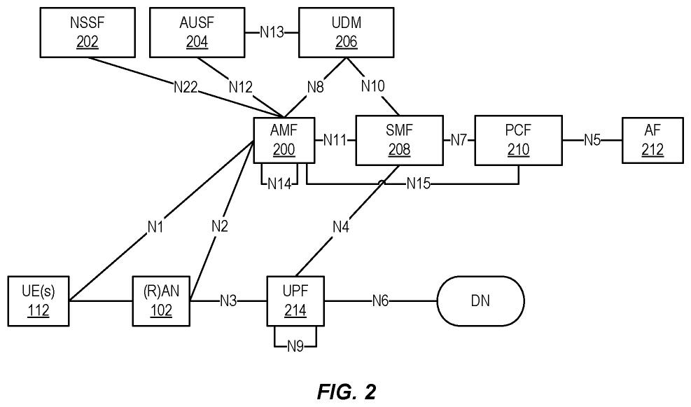

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R (AN) 102 comprises base stations, e.g., such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

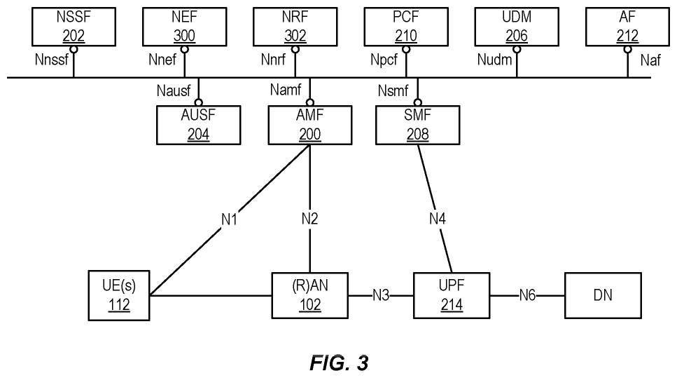

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

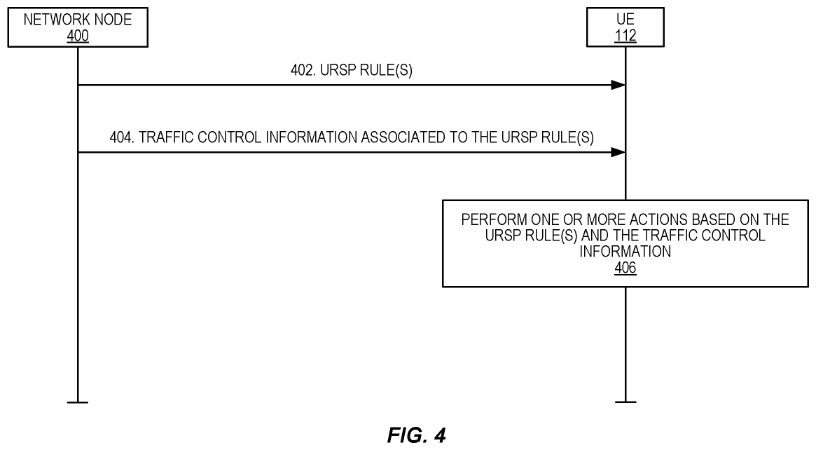

Systems and methods are disclosed herein for supporting traffic management capabilities under control of the network that are not supported in today's URSP. In one embodiment, a URSP option is proposed. In another embodiment, network options are proposed. A hybrid may also be used. In another embodiment, the new information is included as part of the UE policy container in the Npcf_UEPolicyControl UpdateNotify (e.g., in step 6 of FIG. 4.16.11-1 or step 5 of FIG. 4.16.12.1.1-1, in 3GPP TS 23.502).

In one embodiment, a UE 112 needs additional information to determine an action(s) to be taken in regard to a URSP rule(s). This information is referred to herein as “traffic control information” or “TrafficControl” or “traffic control instruction”. In one embodiment, TrafficControl is added into a URSP as an additional parameter(s), e.g., in Route Selection Description or a new element. The following example shows a subset of three URSP rules each containing precedence, S-NSSAI (shown in these examples a “Slice 1”, “Slice 2”, and “Slice 3”), and DNN of Route Selection Description (RSD), and Traffic Control:

### Example

Precedence 1: Slice 1, DNN1, TrafficControl
Precedence 2: Slice 2, DNN1, TrafficControl
Precedence 3: Slice 3, DNN3, TrafficControl

Instead of extending the RSD in the URSP Rule to include Traffic Control, there is another possibility that provides the TrafficControl per set of URSP rules, e.g., all URSP rules belonging to the same UE policy section identified by UE Policy Section Identifier (UPSI) may include the same TrafficControl. As an example, this TrafficControl can have one of the following values (however, additional or alternative values may be defined, e.g., by 3GPP):
None
Now, i.e. directly (i.e., immediately) apply the rule(s).
Release PDU Session and block traffic. This means that the application traffic will not be sent over any PDU Session, not even over a PDU session related to the URSP rule with the “match all” traffic descriptor.

In one embodiment, TrafficControl per URSP rule can have one of the following values (however, additional or alternative values may be defined by, e.g., 3GPP):
None
Now, i.e. directly (i.e., immediately) apply the rule(s)
Release PDU Session and block traffic
Keep PDU session if established. Note this is how it works today-if the UE finds a matching PDU Session, the UE binds the traffic to that PDU Session and keeps that PDU session.
Release PDU session if there is a higher precedence URSP rule
   In another embodiment, the TrafficControl may additionally or alternatively have one of the following values:
Re-register and first release PDU session if there is a higher precedence rule (break before make)
Re-register and release PDU session after establishing a new PDU session due to higher precedence rule (make before break)

In one embodiment, TrafficControl includes commands sent to the UE, e.g., by re-using existing Policy and Control Function (PCF) messages:
Stop using Slice X by all applications/Internet Protocol (IP) streams. This is another slice related rule, which can be implemented in a URSP Rule using Traffic Control set to “Stop”, the traffic descriptor and the RSD including the Slice X as unique component. It is also possible to include a DNN as follows: (Traffic Descriptors, RSD including Precedence 1: Slice 3, DNN=ALL, Traffic Control Stop USING slice X). There are other ways to implement this rule such as removing all related URSP Rules and provision a new one that should be evaluated immediately, or it can be a separate command with “Remove all rules that includes Slice X” and additionally the “Now”, i.e., UE first removes the rules with Slice X″ and then directly applies the remaining rule(s).
Block application or traffic flow from accessing the network, a rule that identities a traffic descriptors and indicates that the traffic matching the traffic descriptors in the URSP Rule is not allowed to access the network even if there are matching rules, e.g. a “Traffic Descriptor: *”, i.e. matching all traffic can be installed with lowest priority while a rule with higher priority blocks the traffic descriptors in the URSP Rule.

### Example: UE has Established a PDU Session for Slice 3 and DNN3

If “keep if established” is used, then the related PDU sessions are continued to be used, even if there are URSP rules with higher precedence.
If “release for available higher precedence rule” would be used and the UE has only registered Slice 2 and Slice 3, then the UE establishes a new PDU session using Slice 2 and DNN1 and terminates or updates the existing PDU session with Slice 3 and DNN3.

More TrafficControl values may be defined, e.g., by 3GPP, enabling additional and/or alternative behavior, e.g.
a value may be defined to indicate, instead of terminating or updating a PDU session, to keep it while establishing a new PDU session
a value may be defined to indicate a new rule for all traffic to stop using a specific slice by any application; impacted applications can use a different slice, where applicable. This may require a new traffic Descriptor, where DNN=ALL and is reserved for that traffic as an example of an implementation.
If “re-register and release for available higher precedence rule” is used, then the UE is forced to update the registration to include Slice 1 into requested NSSAI. Further, and if Slice 1 is then also in Allowed NSSAI, then the UE establishes PDU Session with Slice 1+DNN1 and releases the existing PDU session with Slice 3 and DNN3 (unless used by another traffic stream, application).

In one embodiment, in regard to UE logic for traffic switching, a UE that switches application/IP stream, or any traffic to a new S-NSSAI, first registers to the new slice, where applicable, and is allowed to use the S-NSSAI. Subsequently, the UE establishes a new PDU session for the subject application/IP stream traffic it intends to switch and then switches that traffic to the new PDU session, and new S-NSSAI. After that, the UE can release the old PDU session-thus this example embodiment is make before break.

FIG. 4 illustrates the operation of a network node 400 and a UE 112 in accordance with one example embodiment of the present disclosure. The network node 400 may be, for example, a network node that implements a PCF (i.e., a network node that operates as a PCF or provides the functionality of a PCF). As illustrated, the UE 112 receives, from the network node 400 (e.g., PCF 210), one or more URSP rules and traffic control information (steps 402 and 404). The traffic control information may be in accordance with any of the embodiments described above. While all of the embodiments of the traffic control information, or TrafficControl, described above are applicable here, some example embodiments are as follows. As described above, in one embodiment, the traffic control information is included in the URSP rule(s) as one or more additional parameters, e.g., in the RSD(s) of the URSP rule(s) or a new element. In this case, the traffic control information is included in the individual URSP rule(s). In another embodiment, the traffic control information is associated to a set of URSP rules, where this set of URSP rules includes one or more URSP rules and preferably two or more URSP rules. The set of URSP rules may be, for example, a set of URSP rules belonging to a same UE policy section identified by a UPSI. In another embodiment, the traffic control information includes one or more commands sent to the UE 112, e.g., by re-using existing PCF messages. As discussed above, the command(s) may, in some embodiments, be a command(s) to apply some action to one or more already existing URSP rules at the UE 112. In another embodiment, the traffic control information is included as part of the UE policy container in the Namf_Communication_N1N2MessageTransfer from (V-)PCF to the AMF.

In one embodiment, the traffic control information includes information that indicates when the UE 112 is to (re-)evaluate the associated URSP rule(s) and/or when the UE 112 is to apply results of the (re-)evaluation of the associated URSP rule(s). For example, as described above, in one embodiment, the traffic control information indicates whether the UE 112 is to (re-)evaluate the associated URSP rule(s) immediately or later (e.g., when the UE 112 returns to an idle mode, e.g., 5GMM-IDLE mode). In another embodiment, the traffic control information indicates whether the UE 112 is to apply (e.g., apply the results of the evaluation of) the associated URSP rule(s) immediately (i.e., immediately following the evaluation of the associated URSP rule(s)) or later. In another embodiment, the traffic control information indicates whether the UE 112 is to (re-)evaluate the associated URSP rule(s) and apply the results of the evaluation of the associated URSP rule(s) immediately or later.

In one embodiment, the traffic control information comprises information that indicates that the wireless communication device is to release an associated PDU session and block traffic. In another embodiment, the traffic control information comprises information that indicates: (a) that the wireless communication device 112 is to release an associated PDU session and block traffic, (b) that the wireless communication device 112 is to keep an associated PDU session if established, or (c) that the wireless communication device 112 is to release an associated PDU session if there is a higher precedence URSP rule. In another embodiment, the traffic control information may additionally or alternatively include information that indicates: (a) that the UE 112 is to release an associated PDU session and block traffic, (b) that the UE 112 is to keep an associated PDU session if established, (c) that the UE 112 is to release an associated PDU session if there is a higher precedence URSP rule, (d) that the UE 112 is to re-register and first release an associated PDU session if there is a higher precedence URSP rule, or (e) that the UE 112 is to re-register and release an associated PDU session after establishing a new PDU session due to a higher precedence URSP rule. Note that (a)-(e) are only examples. The traffic control information may additionally or alternatively include information that indicates other traffic-control related actions to be performed by the UE 112. In one embodiment, the traffic control information indicates that the UE 112 is to stop using a particular network slice (e.g., for all applications or IP streams). In one embodiment, the traffic control information indicates that the UE 112 is to block a particular application or traffic flow from accessing the network.

The UE 112 performs one or more actions in accordance with the URSP rule(s) and the traffic control information (step 406).

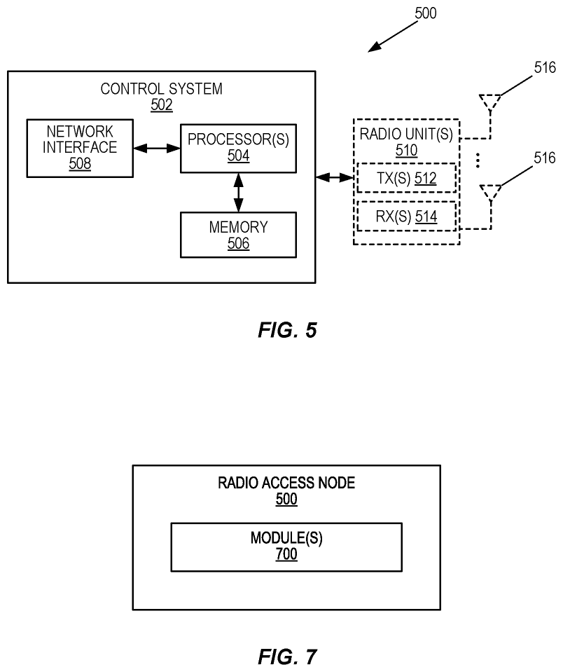

FIG. 5 is a schematic block diagram of a network node 500 according to some embodiments of the present disclosure. Optional features are represented by dashed boxes. The network node 500 may be, for example, the network node 400 having the functionality described herein. As illustrated, the network node 500 includes a one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. The one or more processors 504 operate to provide one or more functions of the network node 500 as described herein (e.g., one or more functions of the network node 400 described herein). In some embodiments, the function(s) are implemented in software that is stored, e.g., in the memory 506 and executed by the one or more processors 504.

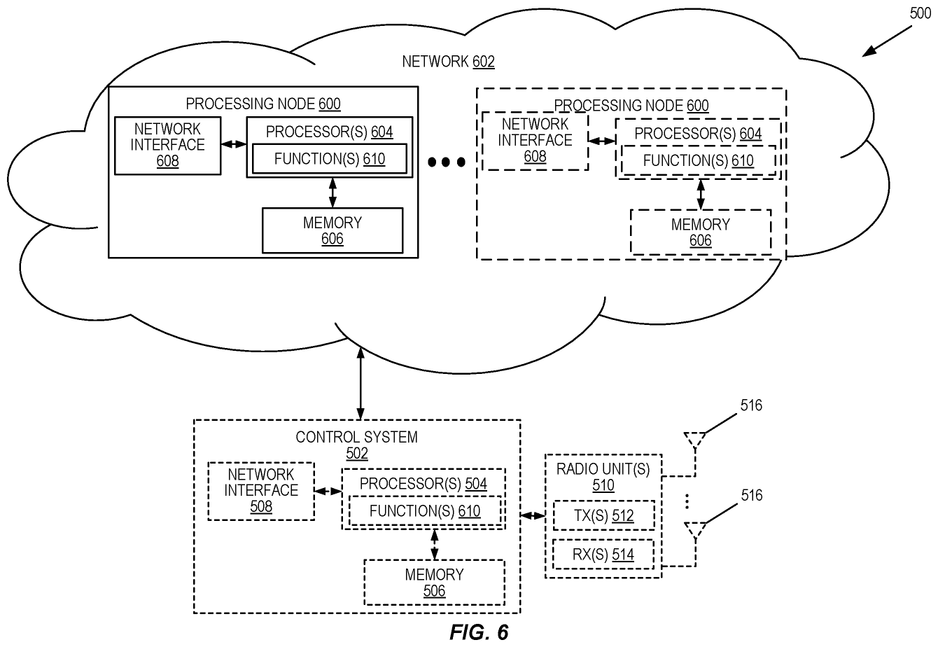

FIG. 6 is a schematic block diagram that illustrates a virtualized embodiment of the network node 500 according to some embodiments of the present disclosure. Again, optional features are represented by dashed boxes. As used herein, a “virtualized” network node is an implementation of the network node 500 in which at least a portion of the functionality of the network node 500 is implemented as a virtual component(s) (e.g., via a virtual machine(s) executing on a physical processing node(s) in a network(s)). As illustrated, in this example, the network node 500 includes one or more processing nodes 600 coupled to or included as part of a network(s) 602. Each processing node 600 includes one or more processors 604 (e.g., CPUs, ASICS, FPGAS, and/or the like), memory 606, and a network interface 608. In this example, functions 610 of the network node 500 described herein (e.g., one or more functions of the network node 400 described herein) are implemented at the one or more processing nodes 600 or distributed across the two or more processing nodes 600 in any desired manner. In some particular embodiments, some or all of the functions 610 of the network node 500 described herein are implemented as virtual components executed by one or more virtual machines implemented in a virtual environment(s) hosted by the processing node(s) 600.

In some embodiments, a computer program including instructions which, when executed by at least one processor, causes the at least one processor to carry out the functionality of the network node 500 or a node (e.g., a processing node 600) implementing one or more of the functions 610 of the network node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the network node 500 according to some other embodiments of the present disclosure. The network node 500 includes one or more modules 700, each of which is implemented in software. The module(s) 700 provide the functionality of the network node 500 described herein. This discussion is equally applicable to the processing node 600 of FIG. 6 where the modules 700 may be implemented at one of the processing nodes 600 or distributed across multiple processing nodes 600.

FIG. 8 is a schematic block diagram of a wireless communication device 800 according to some embodiments of the present disclosure. The wireless communication device 800 may be the wireless communication device 112 or UE. As illustrated, the wireless communication device 800 includes one or more processors 802 (e.g., CPUs, ASICS, FPGAS, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the wireless communication device 800 described above may be fully or partially implemented in software that is, e.g., stored in the memory 804 and executed by the processor(s) 802. Note that the wireless communication device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the wireless communication device 800 and/or allowing output of information from the wireless communication device 800), a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

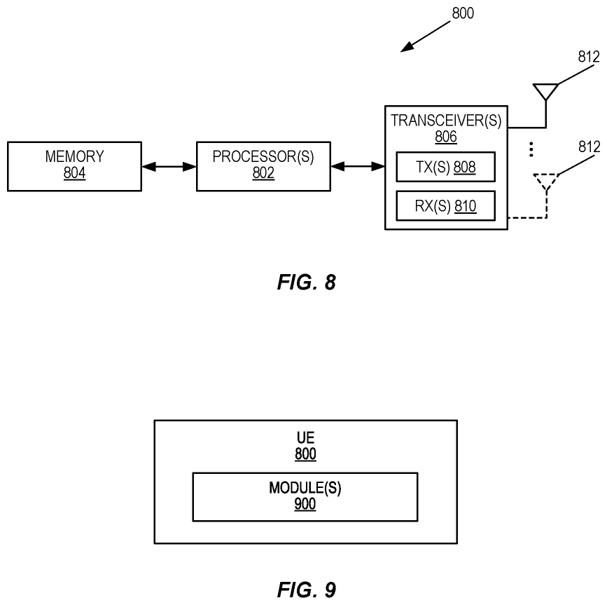

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a wireless communication device (112), the method comprising: receiving (402) one or more User Equipment, UE, Route Selection Policy, URSP, rules from a network node (400); receiving (404) traffic control information associated to the one or more URSP rules; and performing (406) one or more actions based on the one or more URSP rules and the traffic control information.

Embodiment 2: The method of embodiment 1 wherein the traffic control information comprises information that indicates when the wireless communication device (112) is to (re-)evaluate the one or more URSP rules.

Embodiment 3: The method of embodiment 1 wherein the traffic control information comprises information that indicates that the wireless communication device (112) is to (re-)evaluate the one or more URSP rules immediately.

Embodiment 4: The method of embodiment 1 wherein the traffic control information comprises information that indicates when the wireless communication device (112) is to apply results of (re-)evaluation the one or more URSP rules.

Embodiment 5: The method of embodiment 1 wherein the traffic control information comprises information that indicates that the wireless communication device (112) is to apply results of (re-)evaluation of the one or more URSP rules immediately following the (re-)evaluation of the one or more URSP rules.

Embodiment 6: The method of embodiment 1 wherein the traffic control information comprises information that indicates when the wireless communication device (112) is to both (re-)evaluate the one or more URSP rules and apply results of the (re-)evaluation of the one or more URSP rules.

Embodiment 7: The method of embodiment 1 wherein the traffic control information comprises information that indicates that the wireless communication device (112) is to both (re-)evaluate the one or more URSP rules and apply results of the (re-) evaluation of the one or more URSP rules immediately.

Embodiment 8: The method of any of embodiments 1 to 7 wherein the traffic control information comprises information that indicates that the wireless communication device (112) is to release an associated PDU session and block traffic.

Embodiment 9: The method of any of embodiments 1 to 7 wherein the traffic control information comprises information that indicates: (a) that the wireless communication device (112) is to release an associated PDU session and block traffic, (b) that the wireless communication device (112) is to keep an associated PDU session if established, or (c) that the wireless communication device (112) is to release an associated PDU session if there is a higher precedence URSP rule.

Embodiment 10: The method of any of embodiments 1 to 7 wherein the traffic control information comprises information that indicates: (a) that the wireless communication device (112) is to release an associated PDU session and block traffic, (b) that the wireless communication device (112) is to keep an associated PDU session if established, (c) that the wireless communication device (112) is to release an associated PDU session if there is a higher precedence URSP rule, (d) that the wireless communication device (112) is to re-register and first release an associated PDU session if there is a higher precedence URSP rule, or (e) that the wireless communication device (112) is to re-register and release an associated PDU session after establishing a new PDU session due to a higher precedence URSP rule.

Embodiment 11: The method of any of embodiments 1 to 7 wherein the traffic control information comprises information that indicates that the wireless communication device (112) is to stop using a particular network slice (e.g., for all applications or IP streams).

Embodiment 12: The method of any of embodiments 1 to 7 wherein the traffic control information comprises information that indicates that the wireless communication device (112) is to block a particular application or traffic flow from accessing the network.

Embodiment 13: The method of any of embodiments 1 to 12 wherein the one or more URSP rules comprises a URSP rule, and receiving (404) the traffic control information comprises receiving (404) the traffic control information as part of the URSP rule.

Embodiment 14: The method of any of embodiments 1 to 12 wherein the one or more URSP rules comprises a set of URSP rules, and the traffic control information is applicable to the set of URSP rules.

Embodiment 15: The method of embodiment 14 wherein the set of URSP rules comprises one or more URSP rules.

Embodiment 16: The method of embodiment 14 wherein the set of URSP rules comprises two or more URSP rules.

Embodiment 17: The method of any of embodiments 14 to 16 wherein the set of URSP rules belong to a same UE policy section (e.g., identified by a UPSI).

Embodiment 18: The method of any of embodiments 1 to 12 wherein receiving the traffic control information comprises receiving the traffic control information comprised in a UE policy container (e.g., in a Npcf_UEPolicyControl UpdateNotify (e.g., in step 6 of FIG. 4.16.11-1 or step 5 of FIG. 4.16.12.1.1-1, in 3GPP TS 23.502)).

Embodiment 19: The method of any of embodiments 1 to 18 wherein the traffic control information comprises one or more commands.

Embodiment 20: The method of embodiment 19 wherein the one or more commands comprises a command to modify the one or more URSP rules by replacing a particular network slice in the one or more URSP rules with another network slice.

Embodiment 21: The method of any of embodiment 19 wherein the one or more commands comprise a command that instructs the wireless communication device (112) to stop using a particular network slice (e.g., for all applications or IP streams).

Embodiment 22: The method of any of embodiment 19 wherein the one or more commands comprise a command that instructs the wireless communication device (112) to block a particular application or IP stream from accessing the network.

Embodiment 23: A wireless communication device (112) adapted to perform the method of any of embodiments 1 to 22.

Embodiment 24: A method performed by a network node (400), the method comprising: sending (402) one or more User Equipment, UE, Route Selection Policy, URSP, rules to a wireless communication device (112); and sending (404) traffic control information associated to the one or more URSP rules to the wireless communication device (112).

Embodiment 25: The method of embodiment 24 wherein the traffic control information is in accordance with any of embodiments 2 to 22.

Embodiment 26: A network node (400) adapted to perform the method of any of embodiments 24 to 25.

Those skilled in the art will recognize improvements and modifications to the embodiments of the present disclosure. All such improvements and modifications are considered within the scope of the concepts disclosed herein.

1. A method performed by a wireless communication device, the method comprising:
receiving one or more User Equipment, UE, Route Selection Policy, URSP, rules from a network node;
receiving traffic control information associated to the one or more URSP rules; and
performing one or more actions based on the one or more URSP rules and the traffic control information.

2. The method of claim 1, wherein the traffic control information comprises information that indicates when the wireless communication device is to evaluate or re-evaluate the one or more URSP rules.

3. The method of claim 1, wherein the traffic control information comprises information that indicates that the wireless communication device is to evaluate or re-evaluate the one or more URSP rules immediately.

4. The method of claim 1, wherein the traffic control information comprises information that indicates when the wireless communication device is to apply results of evaluation or re-evaluation the one or more URSP rules.

5. The method of claim 1, wherein the traffic control information comprises information that indicates that the wireless communication device is to apply results of evaluation or re-evaluation of the one or more URSP rules immediately following the evaluation or re-evaluation of the one or more URSP rules.

6. The method of claim 1, wherein the traffic control information comprises information that indicates when the wireless communication device is to both evaluate or re-evaluate the one or more URSP rules and apply results of the evaluation or re-evaluation of the one or more URSP rules.

7. The method of claim 1, wherein the traffic control information comprises information that indicates that the wireless communication device is to both evaluate or re-evaluate the one or more URSP rules and apply results of the evaluation or re-evaluation of the one or more URSP rules immediately.

8. The method of claim 1, wherein the traffic control information comprises information that indicates that the wireless communication device is to release an associated Protocol Data Unit, PDU, session and block traffic.

9. The method of claim 1, wherein the traffic control information comprises information that indicates: (a) that the wireless communication device is to release an associated Protocol Data Unit, PDU, session and block traffic, (b) that the wireless communication device is to keep an associated PDU session if established, or (c) that the wireless communication device is to release an associated PDU session if there is a higher precedence URSP rule.

10. The method of claim 1, wherein the traffic control information comprises information that indicates: (a) that the wireless communication device is to release an associated Protocol Data Unit, PDU, session and block traffic, (b) that the wireless communication device is to keep an associated PDU session if established, (c) that the wireless communication device is to release an associated PDU session if there is a higher precedence URSP rule, (d) that the wireless communication device is to re-register and first release an associated PDU session if there is a higher precedence URSP rule, or (e) that the wireless communication device is to re-register and release an associated PDU session after establishing a new PDU session due to a higher precedence URSP rule.

11. The method of claim 1, wherein the traffic control information comprises information that indicates that the wireless communication device is to stop using a particular network slice.

12. The method of claim 1, wherein the traffic control information comprises information that indicates that the wireless communication device is to block a particular application or traffic flow from accessing the network.

13. The method of claim 1, wherein the one or more URSP rules comprises a URSP rule, and receiving the traffic control information comprises receiving the traffic control information as part of the URSP rule.

14. The method of claim 1, wherein the one or more URSP rules comprises a set of URSP rules, and the traffic control information is applicable to the set of URSP rules.

15. The method of claim 14, wherein the set of URSP rules comprises one or more URSP rules.

16. The method of claim 14, wherein the set of URSP rules comprises two or more URSP rules.

17. The method of claim 14, wherein the set of URSP rules belong to a same UE policy section.

18-24. (canceled)

25. A wireless communication device comprising:
one or more transmitters;
one or more receivers; and
processing circuitry associated with the one or more transmitters and the one or more receivers, the processing circuitry configured to cause the wireless communication device to:
receive one or more User Equipment, UE, Route Selection Policy, URSP, rules from a network node;
receive traffic control information associated to the one or more URSP rules; and
perform one or more actions based on the one or more URSP rules and the traffic control information.

26. (canceled)

27. A method performed by a network node, the method comprising:
sending one or more User Equipment, UE, Route Selection Policy, URSP, rules to a wireless communication device; and
sending traffic control information associated to the one or more URSP rules to the wireless communication device.

28-50. (canceled)

51. A network node comprising processing circuitry configured to cause the network node to:
send one or more User Equipment, UE, Route Selection Policy, URSP, rules to a wireless communication device; and
send traffic control information associated to the one or more URSP rules to the wireless communication device.

52. (canceled)
